(19) United States
(12) Patent Application Publication
(10) Pub. No.: US 2018/0189606 A1
(43) Pub. Date: Jul. 5, 2018

(54) METHOD AND DEVICE FOR SUPPORTING CREATION OF TEACHING DATA, PROGRAM AND PROGRAM RECORDING MEDIUM

(71) Applicant: SCREEN HOLDINGS CO., LTD., Kyoto (JP)

(72) Inventor: Jiro TSUMURA, Kyoto (JP)

(21) Appl. No.: 15/736,240

(22) PCT Filed: Jun. 1, 2016
(86) PCT No.: PCT/JP2016/066240

§ 371 Date: Dec. 13, 2017

(30) Foreign Application Priority Data
Jun. 17, 2015 (JP) 2015-121978

(51) Int. Cl. G06K 9/62; G06N 99/00; G06K 9/00

(52) U.S. Cl. CPC G06K 9/6256; G06K 9/00147; G06N 99/005

(57) ABSTRACT

A method is for supporting the creation of a teaching data. The comprises: a displaying step of displaying a teaching image including an object for the creation of a teaching data on a display unit to enable the classification of the object; and a data creating step of receiving a classification result of the object displayed on the display unit and creating the teaching data by associating the classification result and the teaching image.

### CROSS REFERENCE TO RELATED APPLICATION

The disclosure of Japanese Patent Application No. 2015-121978 filed on Jun. 17, 2015 including specification, drawings and claims is incorporated herein by reference in its entirety.

### TECHNICAL FIELD

This invention relates to a technique for supporting the creation of teaching data for machine learning of learning data used to classify an object (cell, bacterium, spheroid or the like) from the form of the object obtained by imaging a carrier carrying cells.

### BACKGROUND ART

In medical and bioscience experiments, cells, bacteria or cell clumps (spheroids) as spherical aggregates of a multitude of cells are cultured in a carrier such as a microwell plate or a transparent container and the cells are imaged in a non-destructive or non-invasive manner during culturing. Then, an attempt is made to assess the quality or the life or death of the object such as the cell or spheroid from an imaged image. At this time, the form of the object is known to be important and a technique for classing the object from form information has been proposed (see, for example, non-patent literature 1, 2).

### CITATION LIST

### Non-Patent Literature

[Non-Patent Literature 1] “Cell Quality Assessment Method by the Cell Image Informatics” by Ryuji Kato, Hiroyuki Honda, Bioengineering, 2010, 88^{th} Vol., 12^{th} Issue, pp. 646 to 648
[Non-Patent Literature 2] Kumamoto University, “Development of Human iPS Cell Form Diagnosis Method using Computer—iPS cells and Guarantee of Automatic Classification and Quality in its differentiation—”, [online], Nov. 11, 2014, [Searched on Jun. 1, 2015], Internet <URL: http://www.kumamoto-u.ac.p/whatsnew/seimei/20141111>

### SUMMARY OF INVENTION

### Technical Problem

Machine learning is used to automatically perform an operation of classifying objects (cells and spheroids) from an original image. For example, in non-patent literature 2, an image of each of “somatic cells”, “complete iPS cells” and “incomplete iPS cells” (corresponding to a “teaching image” of the invention) is prepared as teaching data. Learning data is created by performing machine learning based on a plurality of pieces of teaching data and the above classification is automatically made by a computer based on this learning data. Thus, it is important in enhancing classification accuracy to prepare learning data suitable for machine learning.

However, no specific proposal has been made for an operation of smoothly creating learning data and a large amount of labor has been spent for the creation of learning data. Accordingly, a technique capable of creating learning data by a user friendly operation is desired.

This invention was developed in view of the above problem and aims to provide a teaching data creation support technique capable of creating teaching data for machine learning of learning data used to classify an object from the form of the object obtained by imaging a carrier carrying cells by a user friendly operation.

### Solution to Problem

According to a first aspect of the disclosure, there is provided a teaching data creation support method for machine learning of learning data used to classify an object from the form of the object obtained by imaging a carrier carrying cells. The method comprises: a displaying step of displaying a teaching image including the object for the creation of the teaching data on a display unit to enable the classification of the object; and a data creating step of receiving a classification result of the object displayed on the display unit and creating the teaching data by associating the classification result and the teaching image.

According to a second aspect of the disclosure, there is provided a teaching data creation support device for machine learning of learning data used to classify an object from the form of the object obtained by imaging a carrier carrying cells. The device comprises: a display unit that displays a teaching image including the object for the creation of the teaching data; an input unit that receives a classification result classified based on the teaching image displayed on the display unit; and a data creator that creates the teaching data by associating the teaching image displayed on the display unit and the classification result received by the input unit.

According to a third aspect of the disclosure, there is provided a program for supporting the creation of teaching data for machine learning of learning data used to classify an object from the form of the object obtained by imaging a carrier carrying cells using a computer. The program causes the computer to perform: a displaying step of displaying a teaching image including the object for the creation of the teaching data on a display unit to enable the classification of the object; and a data creating step of receiving a classification result of the object displayed on the display unit and creating the teaching data by associating the classification result and the teaching image.

According to a fourth aspect of the disclosure, there is provided a non-transitory computer readable recording medium recording the program.

### Advantageous Effects of Invention

In this invention, the teaching image including the object for the creation of the teaching data is displayed on the display unit. Thus, a user can classify the object while seeing the image displayed on the display unit. Then, the teaching data is created by associating the classification result of the object by the user and the teaching image. Therefore, the teaching data can be created by a user friendly operation.

All of a plurality of constituent elements of each aspect of the invention described above are not essential and some of the plurality of constituent elements can be appropriately changed, deleted, replaced by other new constituent elements or have limited contents partially deleted in order to solve some or all of the aforementioned problems or to achieve some or all of effects described in this specification. Further, some or all of technical features included in one aspect of the invention described above can be combined with some or all of technical features included in another aspect of the invention described above to obtain one independent form of the invention in order to solve some or all of the aforementioned problems or to achieve some or all of the effects described in this specification.

### BRIEF DESCRIPTION OF DRAWINGS

FIG. 1 is a diagram showing a schematic configuration of a cell determination system equipped with an embodiment of a teaching data creation support device according to the invention.

FIG. 2 is a flow chart showing an example of the machine learning processing for creating learning data by implementing a first embodiment of the teaching data creation support method according to the invention.

FIG. 3 is a flow chart showing an example of a teaching processing as the first embodiment of the teaching data creation support method according to the invention.

FIGS. 4, 5, 6 and 8 are diagrams schematically showing the teaching processing in the first embodiment.

FIG. 7 is a diagram schematically showing the structure of the teaching image.

FIG. 9 is a diagram showing the second embodiment of the teaching data creation support method according to the invention.

FIG. 10 is a diagram schematically showing a teaching processing in the second embodiment.

### DESCRIPTION OF EMBODIMENTS

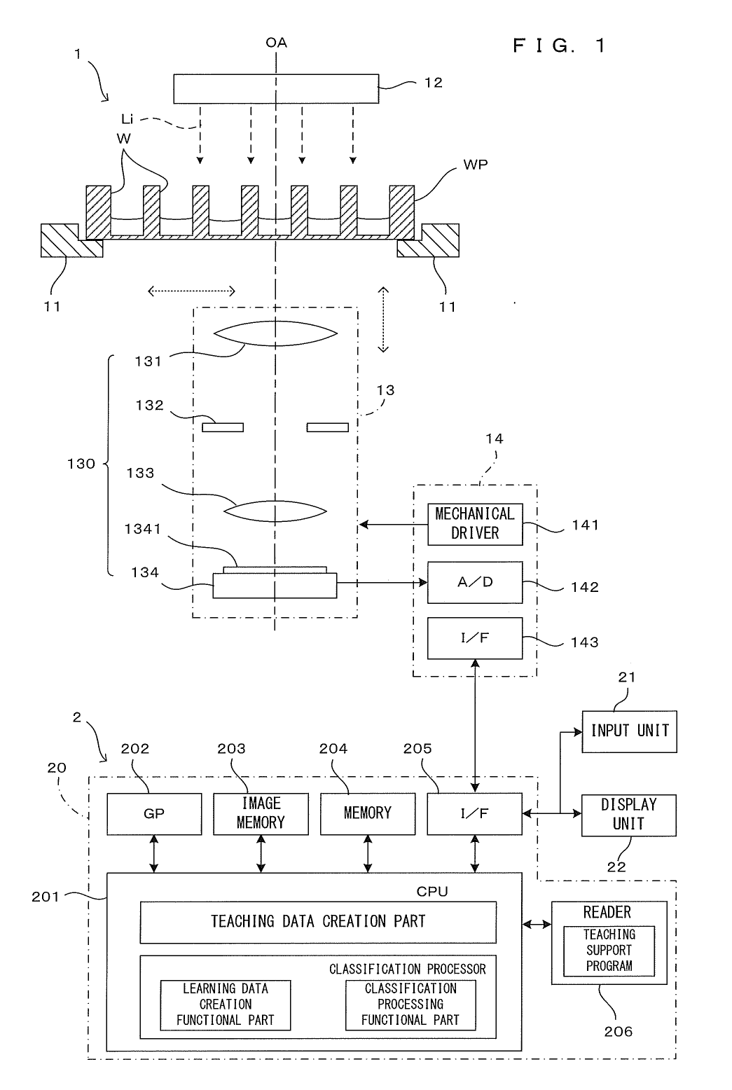

FIG. 1 is a diagram showing a schematic configuration of a cell determination system equipped with an embodiment of a teaching data creation support device according to the invention. This cell determination system includes an imaging unit 1 for imaging specimens in a liquid injected into recesses called wells W formed in the upper surface of a microwell plate WP and an image processing unit 2 for processing an imaged image.

The microwell plate WP is generally used in the fields of drug discovery and bioscience and a plurality of cylindrical wells having a substantially circular cross-section and a transparent and flat bottom surface are provided in the upper surface of a flat plate. The number of the wells W in one microwell plate WP is arbitrary. For example, a microwell plate with 96 (12×8 matrix array) wells can be used. A diameter and a depth of each well W are typically about several mm. Note that the size of the microwell plate and the number of wells to be imaged by this imaging unit 1 are arbitrary without being limited. For example, a microwell plate with 384 wells may be used.

A predetermined amount of a liquid serving as a culture medium is injected into each well W of the microwell plate WP, cells, bacteria and the like cultured under predetermined culture conditions in this liquid are imaged by this imaging unit 1. An appropriate reagent may be added to the culture medium and the culture medium in a liquid state poured into the wells W may be turned into a gel thereafter.

The imaging unit 1 includes a holder 11 for holding the microwell plate WP substantially in a horizontal posture by coming into contact with a peripheral edge part of the lower surface of the microwell plate WP carrying specimens together with the liquid in the respective wells W, an illuminator 12 arranged above the holder 11, an imager 13 arranged below the holder 11 and a controller 14 for controlling the operation of each of these components.

The illuminator 12 emits illumination light Li toward the microwell plate WP held by the holder 11. White light can be, for example, used as the illumination light Li. The specimens in the wells W provided in the microwell plate WP are illuminated from above by the illuminator 12.

The imager 13 is provided below the microwell plate WP held by the holder 11. In the imager 13, an objective lens 131 is arranged at a position right below the microwell plate WP. An optical axis OA of the objective lens 131 is oriented in a vertical direction, and an aperture stop 132, an imaging lens 133 and an imaging device 134 are further provided successively from top to down along the optical axis OA of the objective lens 131. The objective lens 131, the aperture stop 132 and the imaging lens 133 are arranged such that centers thereof are aligned in a row along the vertical direction, and integrally constitute an imaging optical system 130. Note that although the respective components constituting the imager 13 are arranged in a row in the vertical direction in this example, an optical path may be bent by a reflection mirror or the like.

The imager 13 is movable by a mechanical driver 141 provided in the controller 14. Specifically, the mechanical driver 141 moves the objective lens 131, the aperture stop 132, the imaging lens 133 and the imaging device 134 constituting the imager 13 integrally in a horizontal direction, whereby the imager 13 moves in the horizontal direction with respect to the wells W. When imaging objects in one well W are imaged, the mechanical driver 141 positions the imager 13 in the horizontal direction so that an optical axis of the imaging optical system 130 coincides with a center of this well W.

Further, the mechanical driver 141 focuses the imager on the imaging objects by moving the imager 13 in the vertical direction. Specifically, the mechanical driver 141 moves the objective lens 131, the aperture stop 132, the imaging lens 133 and the imaging device 134 integrally upward or downward so that the objective lens 131 is focused on the inner bottom surface of the well W in which the specimens as imaging objects are present.

Further, the mechanical driver 141 moves the illuminator 12 integrally with the imager 13 in the horizontal direction when moving the imager 13 in the horizontal direction. Specifically, the illuminator 12 is arranged such that a center of the light thereof substantially coincides with the optical axis OA of the imaging optical system 130, and moves in the horizontal direction in conjunction with the imager 13 when the imager 13 including the objective lens 131 moves in the horizontal direction. In this way, regardless of which well W is to be imaged, imaging conditions can be satisfactorily maintained by setting a constant illumination condition for the wells W.

The specimens in the well W are imaged by the imager 13. Specifically, light emitted from the illuminator 12 and incident on the liquid from above the well W illuminates the imaging objects, the light transmitted downward from the bottom surface of the well W is condensed by the objective lens 131, and an image of the imaging objects is finally imaged on a light receiving surface of the imaging device 134 via the aperture stop 132 and the imaging lens 133 and received by a light receiving element 1341 of the imaging device 134. The light receiving element 1341 is a linear image sensor and converts a linear image of the imaging objects imaged on a surface thereof into an electrical signal. For example, a CCD sensor can be used as the light receiving element 1341. The light receiving element 1341 relatively scans and moves with respect to the microwell plate WP, whereby a two-dimensional image of the well W is obtained.

An image signal output from the light receiving element 1341 is sent to the controller 14. Specifically, the image signal is input to an AD converter (A/D) 142 provided in the controller 14 and converted into digital image data. The digital image data obtained in this way is output to outside via an interface (I/F) 143.

The image processing unit 2 is provided with a controller 20 including a CPU 201 which functions as a teaching data creator and a classification processor(=learning data creation functional part+classification processing functional part) to be described later by controlling the operation of each system component. The controller 20 further includes a graphic processor (GP) 202 in charge of image processing, an image memory 203 for storing image data and a memory 204 for storing programs to be executed by the CPU 201 and the GP 202 and data generated by these. Note that the CPU 201 may double as the graphic processor 202. Further, the image memory 203 and the memory 204 may be integrated. Further, in this embodiment, a reader 206 is equipped to read a teaching support program for supporting the creation of teaching data, out of the programs to be stored in the memory 204, from a recording medium.

Besides, the controller 20 is provided with an interface (I/F) 205. The interface 205 is in charge of information exchange with users and external apparatuses. Specifically, the interface 205 is connected to the interface 143 of the imaging unit 1 by a communication line and transmits a control command for the CPU 201 to control the imaging unit 1 to the imaging unit 1. Further, the interface 205 receives image data output from the AD converter 142 of the imaging unit 1.

Further, an input unit 21 composed of an input device such as an operation button, a mouse, a keyboard or a tablet or a combination of those is connected to the interface 205. An operation input from a user received by the input unit 21 is transmitted to the CPU 201 via the interface 205. Furthermore, a display unit 22 including a display device such as a liquid crystal display is connected to the interface 205. The display unit 22 presents information such as a processing result to the user by displaying an image corresponding to an image signal given from the CPU 201 via the interface 205. Further, the display unit 22 functions as a man-machine interface for assisting a teaching operation by the user by displaying images for teaching and the like when teaching data is created in accordance with the above teaching support program, i.e. during the execution of a teaching processing.

Note that the image processing unit 2 having the above configuration is substantially the same as the configuration of general person computers. Specifically, a general-purpose computer device can be utilized as the image processing unit 2 of this cell determination system.

Next, the operation of the cell determination system configured as just described is described. In this cell determination system, the imaging unit 1 images a two-dimensional image of each well W and feeds image data to the image processing unit 2. On the other hand, the image processing unit 2 analyzes the received image data, recognizes the forms of objects such as cells, bacteria or spheroids included in the two-dimensional image and classifies the objects. For example, in this embodiment, spheroids are objects as described below, the forms of the spheroids are recognized from image objects obtained by imaging the spheroids and the life and death of the spheroids are classified and determined based on learning data from these forms.

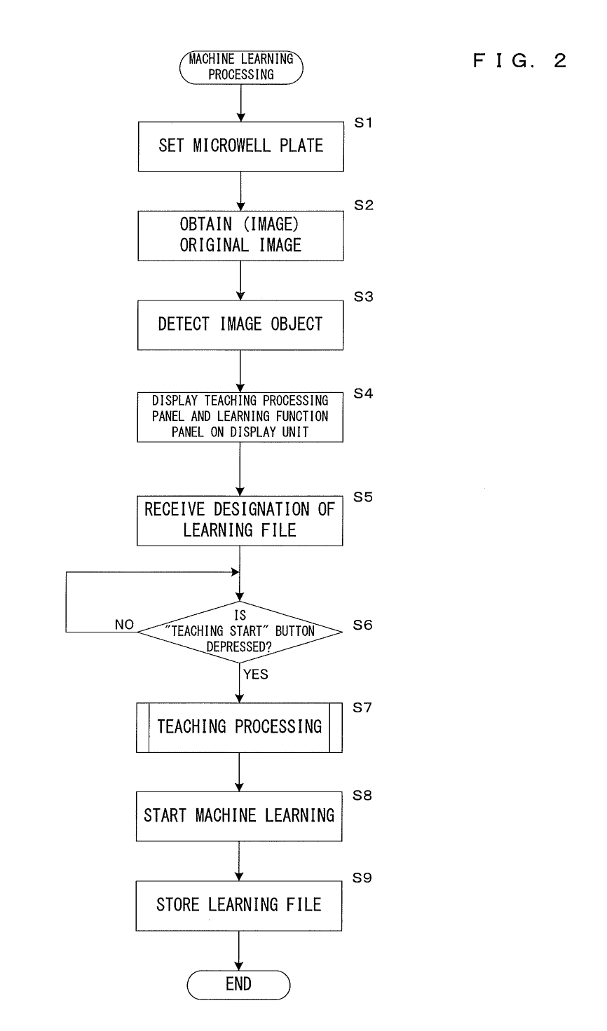

Here, learning data suitable for classification/determination needs to be created by machine learning to accurately perform the above classification and determination. Accordingly, in this embodiment, a machine learning processing described next is performed, and teaching data suitable for machine learning can be created by a user friendly teaching operation in the machine learning processing. The machine learning processing and a teaching data creation support method implemented in the machine learning processing are described in detail with reference to FIGS. 2 to 8 below.

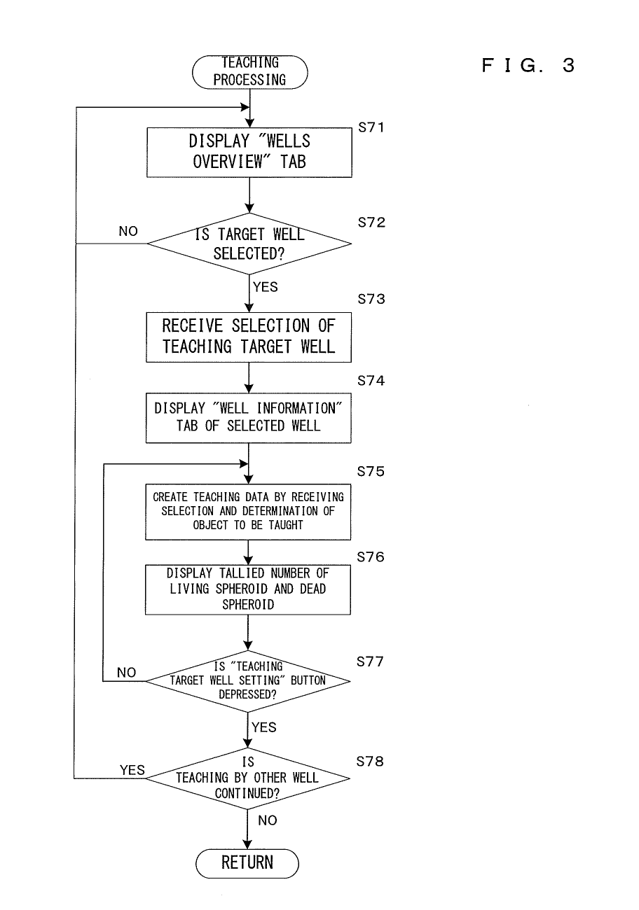

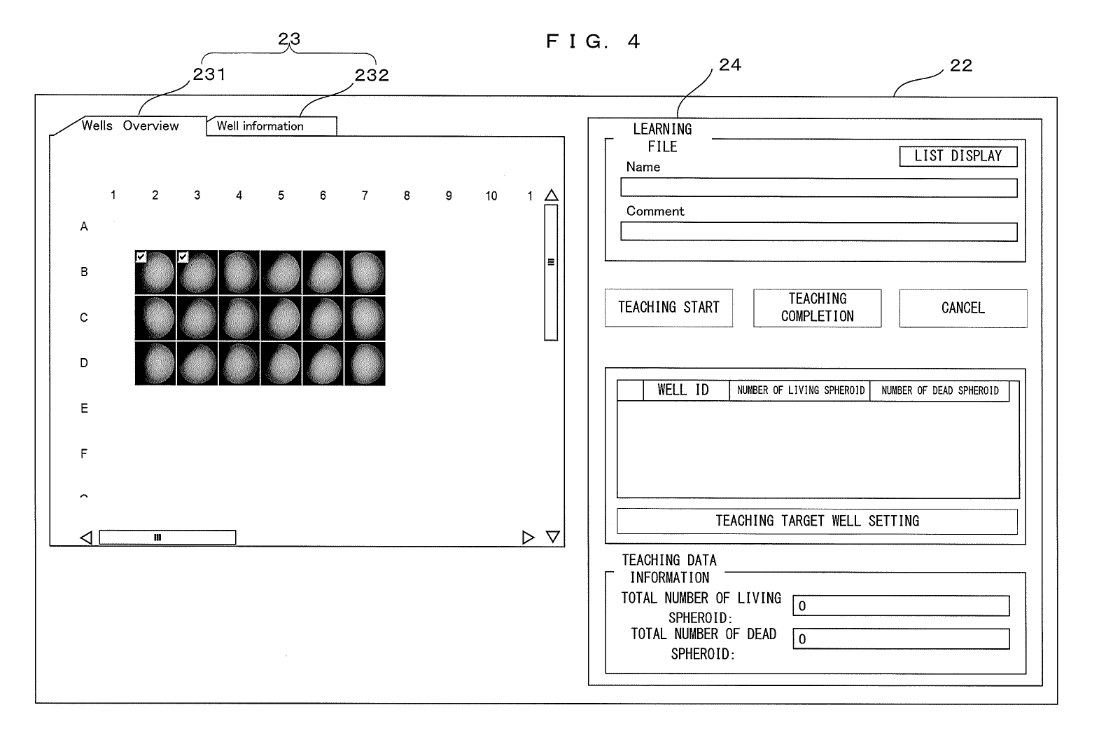

FIG. 2 is a flow chart showing an example of the machine learning processing for creating learning data by implementing a first embodiment of the teaching data creation support method according to the invention. Further, FIG. 3 is a flow chart showing an example of a teaching processing as the first embodiment of the teaching data creation support method according to the invention. Furthermore, FIGS. 4 to 6 are diagrams schematically showing the teaching processing in the first embodiment. The machine learning processing is performed before the life or death of the spheroids is classified and determined based on the learning data, and performed using a microwell plate WP carrying spheroids for learning in at least one or more wells W together with a culture fluid. This machine learning processing is realized by the CPU 201 controlling each component of the device by executing the learning program stored in advance in the memory 204. Further, the teaching data needs to be created for the machine learning processing. The teaching processing for creating the teaching data is realized by the CPU 201 controlling each component of the device by executing the teaching support program read into the memory 204 via the reader 206.

To perform the machine learning, the microwell plate WP carrying the spheroids for learning together with the culture fluid in the wells W is carried into the imaging unit 1 and set on the holder 11 (Step S1). Then, the imaging optical system 130 is positioned with respect to the well W to be imaged and imaging is performed by the imaging device 134 (Step S2). In this way, an original image including the spheroids for learning is obtained.

The graphic processor 202 performs a predetermined image processing on the thus obtained original image to detect a region of image objects included in the original image (Step S3). A known technique can be applied to extract the object in the original image. For example, a method for binarizing the original image using an appropriate threshold value and dividing the original image into a background region and an object region is applicable.

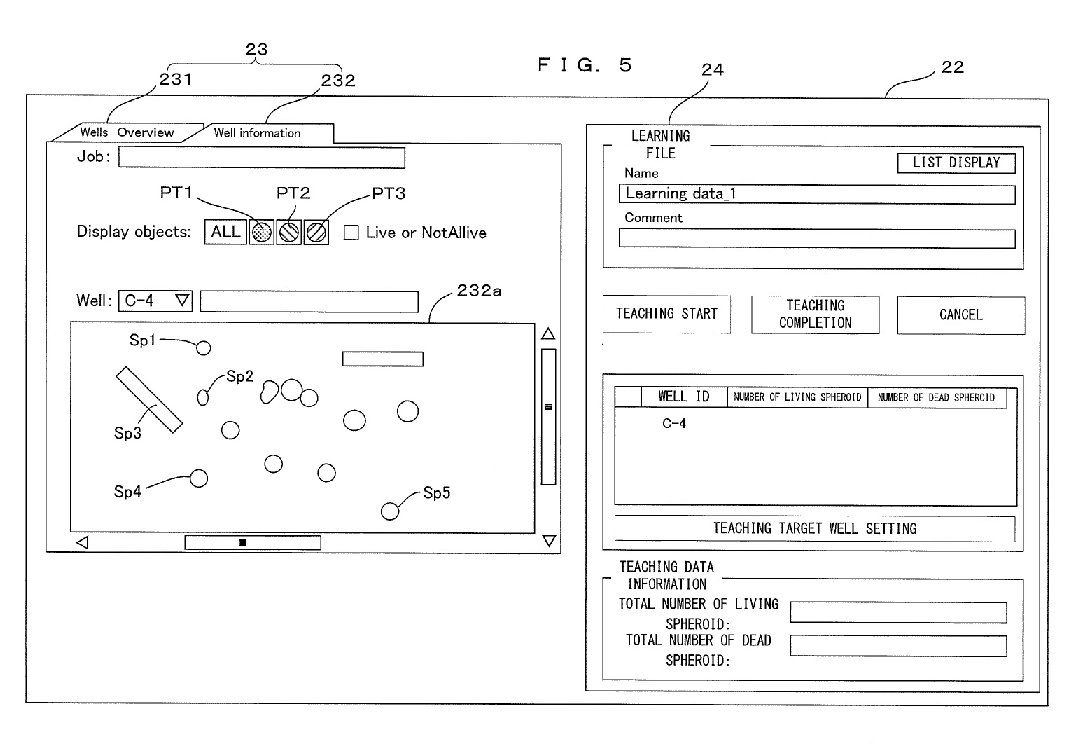

In next Step S4, a teaching processing panel 23 and a learning function panel 24 are displayed on the display unit 22. In the teaching processing panel 23, out of these, two screens, i.e. a “Wells Overview” screen (“hereinafter, referred to as a “WO screen”) 231 and a “Well Information” screen (hereinafter, referred to as a “WI screen”) 232 can be switched by the selection of a tab, for example, as shown in FIGS. 4 and 5. Immediately after the original image of each well W is imaged, a switch is basically made to the WO screen 231 and the original images of the imaged wells W are displayed in matrix as shown in FIG. 4. Note that check boxes in the WO screen 231 of FIG. 4 indicate that the teaching processing has been already completed.

On the other hand, in the learning function panel 24, various pieces of information relating to the machine learning are displayed. In a field of “Learning File” located in an uppermost part of the learning function panel 24, information relating to a learning file including learning data is displayed. Here, the user can designate the file name of the learning data in a box arranged right below “Name”. In this embodiment, a plurality of types of file name designation methods are prepared. Specifically, the file name can be directly input in this box via the input unit 21. Further, a list of existing learning files stored in the memory 204 is displayed by the user pressing a “List Display” button arranged on a right-upper side of the field of “Learning File”. Subsequent to that, the file name selected from the list by the user is input to the above box. Of course, this box may be constituted by a combo box and the user may designate a desired file name from a list displayed in the combo box by selecting the combo box. Note that comments on the learning file displayed in the above box are displayed in “Comment” in the field of “Learning File”.

Three buttons are arranged side by side in a transverse direction right below the field of “Learning File”. If a “Teaching Start” button, out of these, is depressed by the user, the teaching processing is started. Further, if a “Teaching Completion” button is depressed by the user, the teaching processing is completed and a learning processing based on the teaching data by the teaching processing is started. Furthermore, if a “Cancel” button is depressed by the user, the current operation is canceled.

A field of “Teaching Target Well” is provided right below these buttons. In this field of “Teaching Target Well”, a “well ID” for the classification of the well W is set. Further, the number of the spheroids determined to be living (hereinafter, referred to as “living spheroids”) by the user is displayed as a “living spheroid number” and the number of the spheroids determined to be dead (hereinafter, referred to as “dead spheroids”) is displayed as a “dead spheroid number” for each “well ID”. In this way, the living spheroid number and the dead spheroid number are displayed in a table format for each well W to be taught. A “Teaching Target Well Setting” button is arranged right blow this table. If the “Teaching Target Well Setting” button is depressed with the teaching target well selected by the user, the teaching target well is set.

Further, in a lowermost part of the learning function panel 24, a total number of living spheroids and a total number of dead spheroids taught by the teaching processing are calculated and displayed in a field of “Teaching Data Information”.

Referring back to FIG. 2, the machine learning processing is further described. If the learning file is designated on the above learning function panel 24 via the input unit 21 by the user, the controller 20 receives the designation of the learning file (Step S5). If the “Teaching Start” button is depressed after the designation of the learning file (“YES” in Step S6), the controller 20 performs the teaching processing shown in FIG. 3 (Step S7).

In the teaching processing, the WO screen 231 is first displayed on the teaching processing panel 23 for the specification of the teaching target well by the user (Step S71). This causes the original images of the wells W already imaged at the start of the teaching processing to be displayed in matrix. For example, in FIG. 4, six original images are arranged in each of rows B, C and D, i.e. a total of eighteen original images are displayed. Note that, in this specification, the well W in m^{th} row, n^{th} column is called a (m-n) well to specify the original image and the well ID in the learning function panel 224 is also specified by (m-n).

As just described, in this embodiment, the original images of the imaged (B-2), (B-3), . . . (D-7) wells W are displayed on the display unit 22, so that the teaching target well can be easily selected by the user. Note that the “teaching target well” means the well W judged by the user to include the spheroids suitable to create teaching data, and an image including the above spheroids (hereinafter, referred to as a “teaching image”) is reflected in the original image of the teaching target well.

When the teaching target well is selected by the user in next Step S72, the controller 20 receives the selection of the teaching target well (Step S73) and displays the WI screen 232 corresponding to the selected well W (Step S74). In this way, for example as shown in FIG. 5, the WI screen 232 of the selected (C-4) well W is displayed on the display unit 22 and the user can observe a partial enlarged view of the original image of the teaching target well (here, (C-4) well W) in an image display region 232a of the WI screen 232. Here, a case where three types of teaching images, i.e.:
a teaching image including living spheroids Sp1, Sp4 and Sp5,
a teaching image including a dead spheroid Sp2, and
a teaching image including debris,
   are included in the original image of the (C-4) well W for description. Note that the “debris” means foreign matters other than the living spheroids and the dead spheroids, e.g. fine dust, dirt, damage and smear of the microwell plate WP, and the like. Such an image of foreign matters obstructs the creation of the teaching data. Thus, it is desirable to exclude the “debris” from the teaching data as described later.

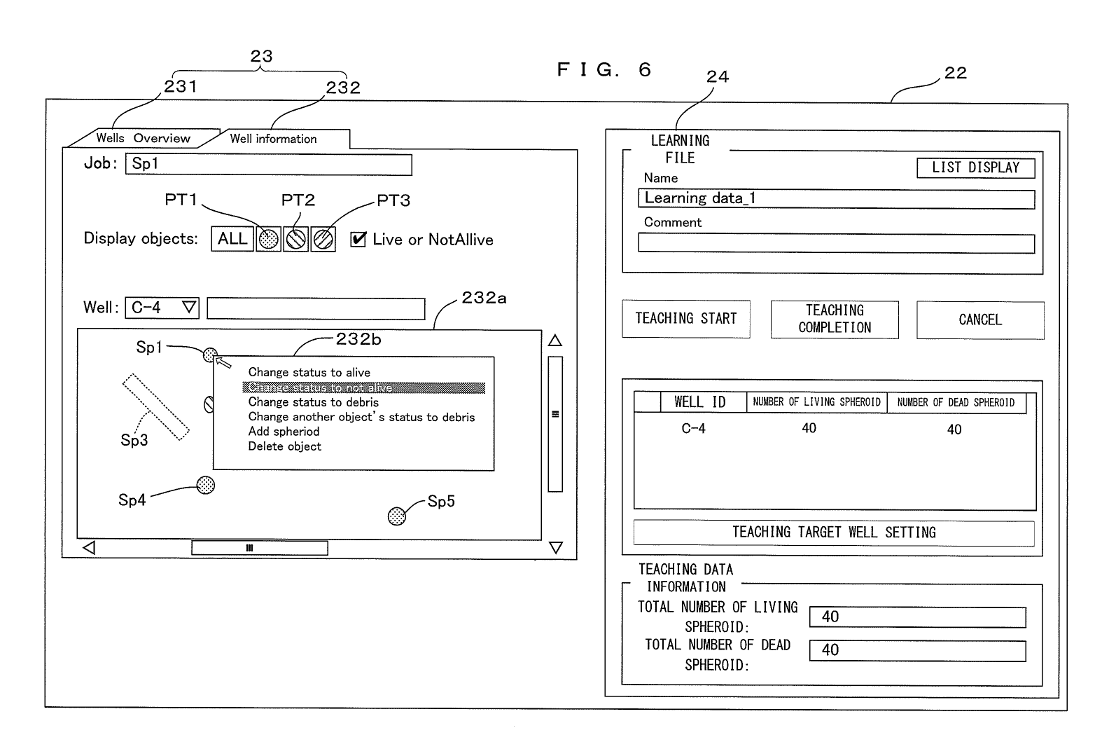

A plurality of spheroids are displayed in the WI screen 232 of the (C-4) well W as shown in FIG. 5. To create the teaching data, the user determines whether some or all of those spheroids are “living spheroids”, “dead “spheroids” or “debris” and classifies those spheroids into three types. More specifically, the user selects one of the spheroids displayed in the WI screen 232 as an image object to be taught by operating the input unit 21 and classifies this spheroid. Upon receiving such a user operation received by the input unit 21, the controller 20 specifies the image object selected by the user and performs an operation of setting a classification result for this image object (hereinafter, referred to as a “job”) (Step S75). Contents of this job are described in detail with reference to FIG. 6.

When the spheroid Sp1 is, for example, selected by the user, the controller 20 displays “Sp1” indicating the selected spheroid Sp1 as a job name in a field of “Job” of the teaching processing panel 23. Further, the controller 20 can set various statuses and add processings for the spheroid Sp1 by displaying a popup screen 232b at a position near the spheroid Sp1. Here, six types of operations, i.e. operations of:
changing the status of the selected spheroid to “living spheroid”,
changing the status of the selected spheroid to “dead spheroids”,
changing the status of the selected spheroid to “debris”,
changing the statuses of the unselected spheroids to “debris”,
adding the spheroid, and
deleting the selected spheroid,
   successively from above are possible.

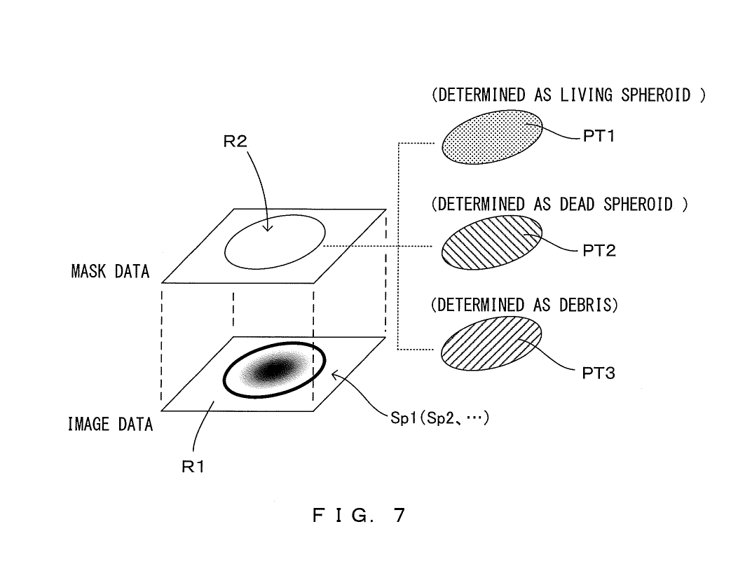

Further, in this embodiment, the teaching image including the selected spheroid is displayed based on image data of an object region R1 including this spheroid, mask data specifying a region R2 corresponding to this spheroid and color data of color supposed to be assigned to the above region R2 as shown in FIG. 7. That is, the image data is data representing an image object extracted from the original image. Further, the mask data represents the form of the selected spheroid and the form of the spheroid can be specified based on this mask data. Furthermore, the color data is set according to the status of the spheroid. In this embodiment, the color data corresponding to determination setting is set and the color of the region R2 is changed every time determination is made by the user. Thus, the user can easily visually confirm under which of “living spheroid (pattern PT1 is given in FIG. 7), “dead spheroid (pattern PT2 is given in FIG. 7) and “debris (pattern PT3 is given in FIG. 7) each spheroid falls by seeing the image displayed in the WI screen 232. Further, whether or not determination has been already made can be also easily visually confirmed. Note that a check box “Live or NotAlive” in FIG. 6 is for setting whether or not to display only the living spheroids and dead spheroids in the image display area 232a, the debris Sp3 can be hidden by setting a check, and the teaching processing can be more smoothly performed.

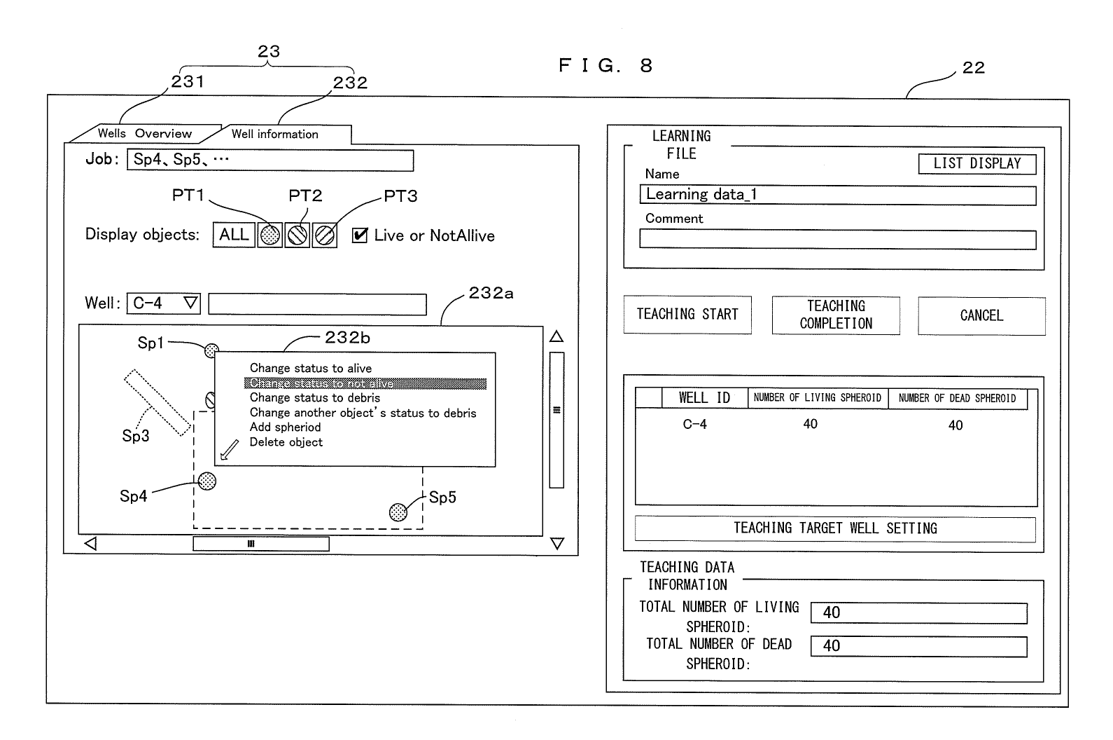

Although the above determination is made to classify the spheroid after the individual spheroid is selected here, a plurality of spheroids may be selected and the above classification may be made therefor. For example, a plurality of spheroids Sp4, Sp5 may be collectively selected by designating a selection range, for example, as shown by broken line in FIG. 8 and those may be classified as the same type. Further, a plurality of spheroids may be successively selected while depressing a specific key (Ctrl key of the keyboard) of the input unit 21.

Further, when the determination setting of the selected spheroid is performed, the controller 20 associates data obtained by excluding the color data from the teaching image (=image data +mask data) and data representing a determination result with each other, creates this as teaching data and stores the teaching data in the memory 204. Further, the controller 20 excludes the “debris”, tallies the numbers of the living spheroids and the dead spheroids and displays the tallied numbers (Step S76). Specifically, the controller 20 tallies the number of the living spheroids and the number of the deal spheroids based on the determination result newly given in Step S75 and the already existing determination result for the well W (well W having the well ID of (C-4) in FIG. 6) for which the teaching processing is currently being performed, and displays the tallied numbers in a middle table of the learning function panel 24. Further, the number of the living spheroids and the number of the dead spheroids are tallied for all the wells W to be taught, and displayed in a field of teaching data information arranged in a lowermost part of the learning function panel 24. In this way, the user can grasp the teaching data numbers of the living spheroids and the dead spheroids in real time during the teaching processing and can easily judge whether to continue, end or stop the teaching processing.

The creation of the teaching data performed for one teaching target well W in this way (Step S75) is repeated until the “Teaching Target Well Setting” button of the learning function panel 24 is depressed. When the “Teaching Target Well Setting” button is depressed (“YES” in Step S77), an advance is made to next Step S78 and the controller 20 determines whether or not to continue the creation of the teaching data using the spheroids carried in the other wells W. In this embodiment, until the “Teaching Completion” button is depressed, the controller 20 determines to continue the creation of the teaching data and returns to Step S71 to create new teaching data by performing the above series of operations. On the other hand, when the “Teaching Target Well Setting” button is depressed (“NO” in Step S78), the controller 20 ends the teaching processing. Then, the controller 20 reads the teaching data stored in the memory 204 and starts the machine learning (Step S8). Further, the controller 20 writes learning data created by the machine learning in the learning file designated in Step S5 and stores this learning file in the memory 204 (Step S9).

As described above, in this embodiment, the teaching image for creating the teaching data for the machine learning is displayed on the display unit 22 and the teaching data is created by the user determining and classifying the spheroids while seeing the display contents. Thus, the teaching data can be created by a user friendly operation. As a result, time, labor and the like required for the creation of the teaching data can be drastically reduced.

Further, in the above embodiment, the spheroids for teaching are classified as any one of three types, i.e. “living spheroid”, “dead spheroid” and “debris”, and the teaching data is created by extracting the “living spheroids” and “dead spheroids” relating to the learning data, out of these. Highly accurate teaching data is obtained by omitting the “debris” in this way.

Further, the numbers of the spheroids classified as the “living spheroids” and the “dead spheroids” are displayed on the display unit 22 and the teaching data number of the “living spheroids” and the teaching data number of the “dead spheroids” are respectively differently notified to the user. Thus, the user can perform a suitable teaching processing by referring to these numerical values. This is because the number of pieces of the teaching data of each classification (e.g. the living spheroid number and the dead spheroid number in this embodiment, an image number relating to “somatic cells”, an image number relating to “complete iPS cells” and an image number relating to “incomplete iPS cells” in non-patent literature 2) needs to be about the same. Even if this condition is satisfied, the machine learning cannot be said to be proper if the teaching data number of each classification is small. Under such a situation, the number of pieces of already created data of each classification can be known in real time during the teaching processing according to this embodiment. As a result, a suitable number of pieces of teaching data for machine learning can be created and the accuracy of the machine learning can be enhanced.

Here, it is desirable to consider the sum of the living spheroid number and dead spheroid number and a ratio of the living spheroid number and the dead spheroid number as numbers suitable for the machine learning as described. Thus, when the “Teaching Completion” button is depressed in the above embodiment (“NO” in Step S78), the controller 20 may determine whether or not the following two data number conditions are both satisfied:
the number is above a learning allowable number
the ratio is within a range of a learning allowable ratio.
   A transition is made to the machine learning when the two conditions are both satisfied while a transition is restricted and a message or the like proposing additional teaching of teaching data may be notified unless otherwise. In this way, proper machine learning can be ensured.

In the above embodiment, when the spheroid displayed on the display unit 22 is classified, the display of the spheroid on the display unit 22, specifically the color, is changed according to the classification result. Thus, the user can easily visually confirm under which of “living spheroid”, “dead spheroid” and “debris” each spheroid falls and can also easily visually confirm whether or not each spheroid has been already determined and classified.

In the above first embodiment, the microwell plate WP carried into the imaging unit 1 is not specially devised and the user needs to create the teaching data while distinguishing the living spheroids and the dead spheroids normally cultured and mixed at a random ratio. Further, the purpose of culturing is to produce the living spheroids and the dead spheroids included in the well W generally tends to be less than the living spheroids. Thus, it may be difficult to find out the dead spheroid number not smaller than a fixed number while keeping the above ratio within the learning allowable ratio. This may stand as an obstacle in reducing time and labor required for the teaching processing.

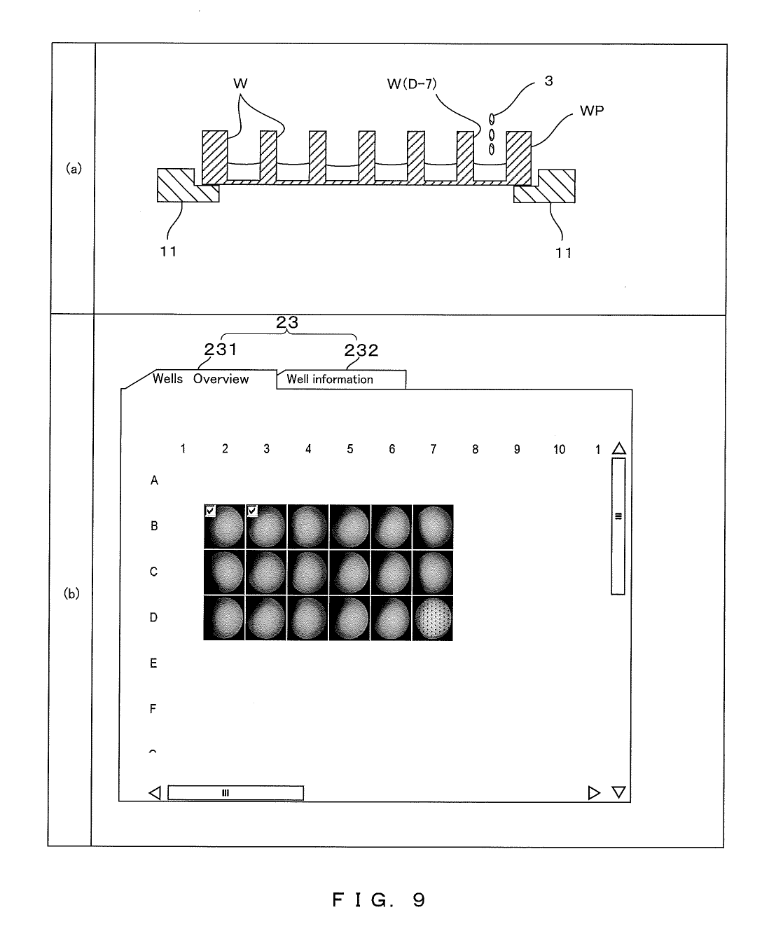

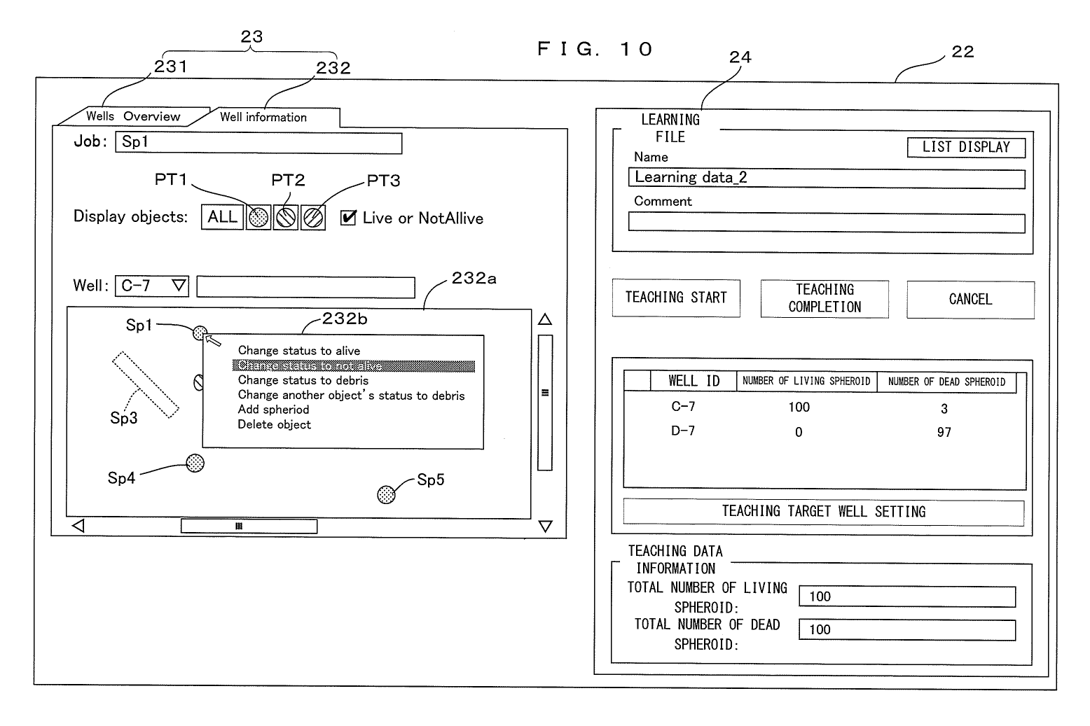

However, it is relatively easy to prepare a large number of dead spheroids by using a drug, and time and labor required for the teaching processing can be reduced by considering this point. A second embodiment of the teaching data creation support method according to the invention is described below with reference to FIGS. 9 and 10.

FIG. 9 is a diagram showing the second embodiment of the teaching data creation support method according to the invention. FIG. 10 is a diagram schematically showing a teaching processing in the second embodiment. This second embodiment largely differs from the first embodiment in that a drug 3 for killing spheroids is injected into one well W ((D-7) well W in this embodiment) out of a plurality of wells W provided in a microwell plate WP to substantially kill the spheroids present in this (D-7) well W as shown in a field (a) of FIG. 9 and the other configuration is basically the same as in the first embodiment. Thus, the following description is centered on points of difference and the description of the same configuration is omitted.

Also in the second embodiment, the microwell plate WP is carried into the imaging unit 1 and set on the holder 11 (Step S1) as in the first embodiment. Then, the imaging optical system 130 is positioned with respect to the wells W to be imaged and imaging is performed by the imaging device 134 (Step S2). In this way, original images including spheroids for learning are obtained. Then, the original images of the imaged wells W are displayed in matrix in the WO screen 231 of the teaching processing panel 23 as shown in a field (b) of FIG. 9. In the second embodiment, the spheroids present in the (D-7) well W described above are almost totally dead. Thus, if this (D-7) well W is selected as the teaching target well, most of the spheroids included therein are “dead spheroids” and the user can determine and classify the spheroids, assuming that. For example, many of the spheroids present in the (D-7) well W can be collectively selected and determine and classify them as “deal spheroids”, with the result that the teaching data of many “dead spheroids” can be relatively easily and quickly created by using the (D-7) well as displayed in a middle table of the learning function panel 24, for example, as shown in FIG. 10.

Then, the well into which the above drug 3 is not injected, e.g. a (C-7) well W as shown in FIG. 10 is selected as a new teaching target well and the teaching data of living spheroids is created as in the first embodiment, whereby the above two data number conditions can be satisfied in a relatively short time and with less labor. Specifically, by preparing normally cultured wells W and a well W having a ratio of dead spheroids forcibly drastically increased and performing the teaching processing using these, time and labor required for the teaching processing can be further reduced.

As described above, in the above embodiments, the image processing unit 2 functions as a “teaching data creation support device” of the invention, and the controller 20 functions as a “data creator” of the invention. Further, Steps S74, S75 and S76 respectively correspond to examples of a “displaying step”, a “data creating step” and a “notifying step” of the invention. Further, a step of changing the color of the region R2 according to the determination setting every time the determination is made by the user in Step S75 corresponds to an example of a “display changing step” of the invention. Further, the living spheroid number and the dead spheroid number correspond to examples of a “teaching data number of each type” of the invention. Furthermore, the living spheroid number and the dead spheroid number respectively correspond to examples of the “number of living objects” and the “number of dead objects”.

Note that the invention is not limited to the above embodiments and various changes other than those described above can be made without departing from the gist of the invention. For example, although the spheroids are treated as “objects” of the invention and the teaching data for classifying the spheroids into two types, i.e. living spheroids and dead spheroids is created in the above embodiments, the same applies also when cells or bacteria are treated as the “objects” of the invention. Further, the content of classification is not limited to classification into two living and dead types. For example, also in the case of creating teaching data for machine learning to classify spheroids, cells or bacteria into three or more types, the invention can be applied. Further, also in the case of creating teaching data for machine learning to classify objects into “debris” and “non-debris”, the invention can be applied also in the case.

Further, although the number of pieces of the teaching data of each type is notified to the user by displaying the living spheroid number and the dead spheroid number on the display unit 22 in the above embodiments, a notifying means is not limited to the display unit 22 and notification may be made by another notifying means such as printing on a sheet, sound or the like.

Further, although the image processing unit 2 equipped together with the imaging unit 1 in the cell determination system functions as the “teaching data creation support device” of the invention in the above embodiment, the “teaching data creation support device” according to the invention may be configured by a configuration not including the imaging unit 1. Further, the invention effectively functions also in a mode for receiving image data of an original image via the reader 206.

Further, although the invention is carried out by the CPU 201 executing the control program stored in the memory 204 in advance in the above embodiment, a general-purpose computer device can be used as the image processing unit 2 in this embodiment as described above. Thus, the present invention can be provided to the user as a teaching support program for causing such a computer device to perform the above teaching processing or an appropriate recording medium recording this program, on the assumption that the program is read into the computer device. In this way, a new function can be added, for example, to a cell determination system already in operation.

Further, in the above embodiments, the teaching support program for implementing the teaching data creation support method is recorded in a non-transitory computer readable recording medium such as a CD-ROM, an optical disc, a magneto-optical disc or a nonvolatile memory card, read from this recording medium using the program stored in the memory 204 as a code, and executed in the computer. That is, the recording medium having recorded the above program and the computer program itself are also included in one embodiment of the invention.

Although the invention has been described by way of the specific embodiments above, this description is not intended to be interpreted in a limited sense. By referring to the description of the invention, various modifications of the disclosed embodiments will become apparent to a person skilled in this art similarly to other embodiments of the invention. Hence, appended claims are thought to include these modifications and embodiments without departing from the true scope of the invention.

### INDUSTRIAL APPLICABILITY

This invention can be applied to techniques in general for supporting the creation of teaching data for machine learning of learning data used to classify an object (cell, bacteria, spheroid or the like) from the form of the object obtained by imaging a carrier carrying cells.

### REFERENCE SIGNS LIST

2 image processing unit (teaching data creation support device)
20 controller (data creator)
21 input unit
22 display unit
23 teaching processing panel
24 learning function panel
201 CPU (data creator)
231 WO screen
232 WI screen
Sp1-Sp5 spheroid
W well
WP microwell plate (carrier)

1. A teaching data creation support method for machine learning of learning data used to classify an object from the form of the object obtained by imaging a carrier carrying cells, the method comprising:
a displaying step of displaying a teaching image including the object for the creation of the teaching data on a display unit to enable the classification of the object; and
a data creating step of receiving a classification result of the object displayed on the display unit and creating the teaching data by associating the classification result and the teaching image.

2. The teaching data creation support method according to claim 1, further comprising:
a notifying step of dividing the classification result into a plurality of types and notifying the number of pieces of the teaching data of each type.

3. The teaching data creation support method according to claim 2, wherein:
in the data creating step, a plurality of objects are displayed on the display unit and the objects excluding the objects not employed as the teaching data, out of the plurality of objects, are divided into two types based on whether the objects are living or dead; and
in the notifying step, the number of the living objects and the number of the dead objects are displayed and notified.

4. The teaching data creation support method according to claim 3, wherein:
the creation of the teaching data is finished when the sum of the number of the living objects and the number of the dead objects exceeds a learning allowable number and a ratio of the number of the living objects and the number of the dead objects is kept within a range of a learning allowable ratio.

5. The teaching data creation support method according to claim 2, further comprising:
a display changing step of changing the display of the object on the display unit according to the classification result if the object displayed on the display unit is classified.

6. A teaching data creation support device for machine learning of learning data used to classify an object from the form of the object obtained by imaging a carrier carrying cells, the device comprising:
a display unit that displays a teaching image including the object for the creation of the teaching data;
an input unit that receives a classification result classified based on the teaching image displayed on the display unit; and
a data creator that creates the teaching data by associating the teaching image displayed on the display unit and the classification result received by the input unit.

7. The teaching data creation support device according to claim 6, wherein:
the data creator divides the classification result into a plurality of types and notifies the number of pieces of the teaching data of each type.

8. A non-transitory tangible machine-readable medium having a program for supporting the creation of teaching data for machine learning of learning data used to classify an object from the form of the object obtained by imaging a carrier carrying cells using a computer, the program causing the computer to perform:
a displaying step of displaying a teaching image including the object for the creation of the teaching data on a display unit to enable the classification of the object; and
a data creating step of receiving a classification result of the object displayed on the display unit and creating the teaching data by associating the classification result and the teaching image.

9. (canceled)

10. The teaching data creation support method according to claim 3, further comprising:
a display changing step of changing the display of the object on the display unit according to the classification result if the object displayed on the display unit is classified.

11. The teaching data creation support method according to claim 4, further comprising:
a display changing step of changing the display of the object on the display unit according to the classification result if the object displayed on the display unit is classified.
